(19) United States
(12) Patent Application Publication
(10) Pub. No.: US 2011/0226891 A1
(43) Pub. Date: Sep. 22, 2011

(54) Airplane and space shuttle ejection seat

(76) Inventor: Hien Minh Tran, Cumming, GA (US)

(21) Appl. No.: 12/661,403

(22) Filed: Mar. 17, 2010

(51) Int. Cl. B64C 31/02; B64D 25/10

(52) U.S. Cl. 244/16; 244/122 A

(57) ABSTRACT

Ejection seats have been on the road towards perfection ever since they were first made. But there are still too many situations that can't be avoided with just one function, ejecting and parachuting down. We have attempted to take it a few steps further: adding a small jet pack and glider wings. This way, pilots and astronauts can apply it in their emergency escape routines. Using the small jet pack, astronauts can push themselves on their way back to the blue planet and pilots can get themselves out of a danger zone quickly. This can also be a wonderful outdoor sport or activity.

### FIELD OF THE INVENTION

This invention relates to the ejection of the pilot's seat in an airplane or space shuttle. This includes the invention of a special pilot chair, and armrests. It is also relevant to gliders.

### HISTORY OF INVENTION

Since the invention of the space shuttles, and even airplanes, many have flocked to find a way to let pilots eject from their planes safely. The most popular was the invention of a seat that would spring many feet upwards. It would then either let the pilot open the parachute manually, or at a specific timing. Another invention that is related to this is the glider. The difference is that our contains compartments that store oxygen, supplies, and a jet pack.

### SUMMARY OF INVENTION

This invention makes it a lot safer for pilots when their planes or shuttles have a technical error or anything of the sort. When the pilot activates the ejection, a spring pushes the back and only the back part of the seat up, making the pilot as if he or she was standing. Straps and belts will form a harness for the pilot to stay on the back of the seat. There are also boxes for first aid and weapons, an oxygen tank, and a jet pack. Depending on the situation, the pilot could deploy glider wings after the seat springs up, use the jet pack to get themselves out of the danger zone, or, in the case of an astronaut, to send themselves on the course towards the atmosphere. When the glider wings are out, if the pilot happens to be in space, the air mask, and tank will still be connected, and all they have to do is point their jet pack the opposite way they want to go and press a button on the handles to activate the jet pack. A pilot that is inside the atmosphere can also use the glider wings like a bird by flapping it to gain elevation or turn to one side. This is better than a parachute because it can also dodge enemy fighter jets and others of the sort (even dangers from the ground). Last, in case of an error, a parachute, doubling as the headrest, could be deployed.

### BRIEF DESCRIPTION OF DRAWINGS

FIG. 1 A front view of a pilot or astronaut with the glider wings out.

FIG. 2 A front-side view of the pilot or astronaut and the ejection seat in the cockpit.

FIG. 3 A side view of the pilot and the seat in the cockpit.

FIG. 4 A back view of the ejection seat with the armrests moving out into glider wings.

FIG. 5 A front view of what will happen if the jetpack and/or glider wings fail. The pilot's or astronaut's seat will deploy a parachute once they push one of the two buttons at their shoulders.

### DETAILED DESCRIPTION OF DRAWINGS

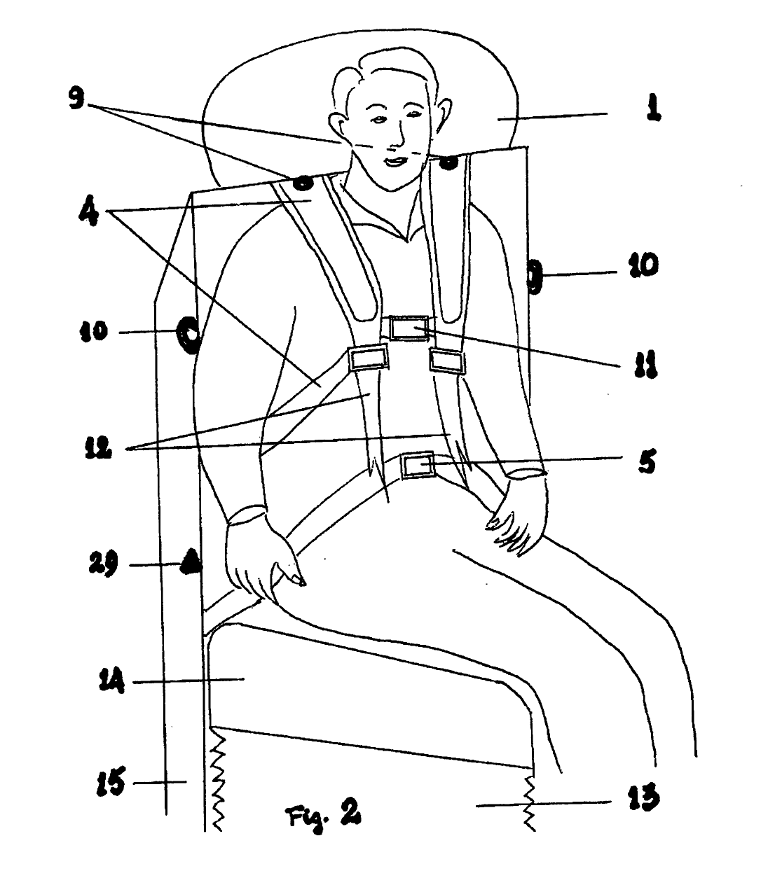

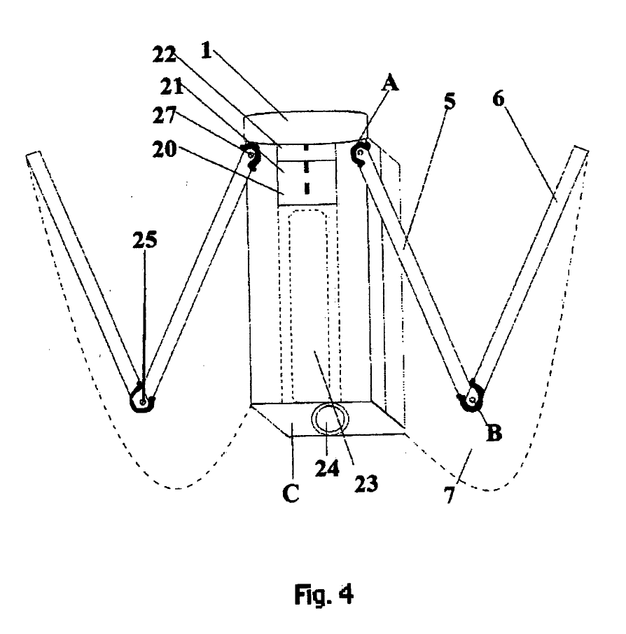

The arm mechanism of the glider FIG. 4 is activated when the button FIG. 2, 10 is press. This reaction is caused by the springs FIGS. 4 A&B, which are locked in place by an external locked pin button FIG. 2, 10. When the external pin FIG. 2, 10 is taken out, the springs FIGS. 4, A&B, along with the force of the wind, will spring out and lock (there are two locks: upper lock FIG. 4, 27 and lower lock FIG. 4, 25) into its position.

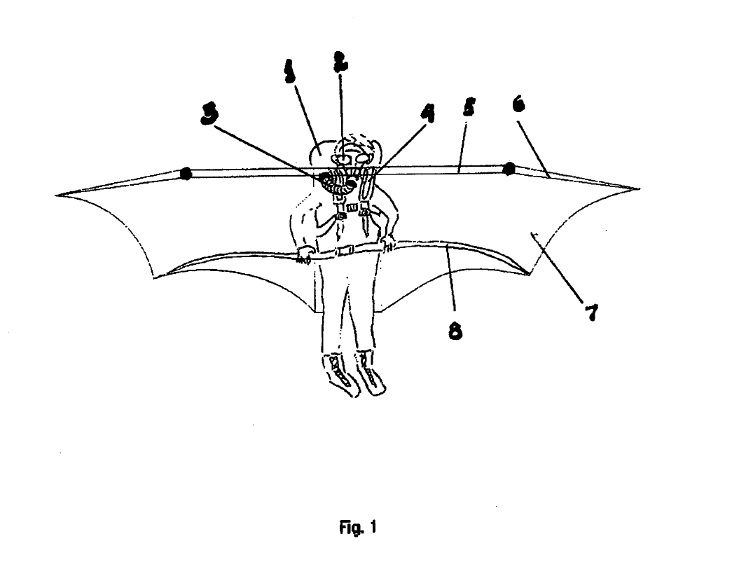

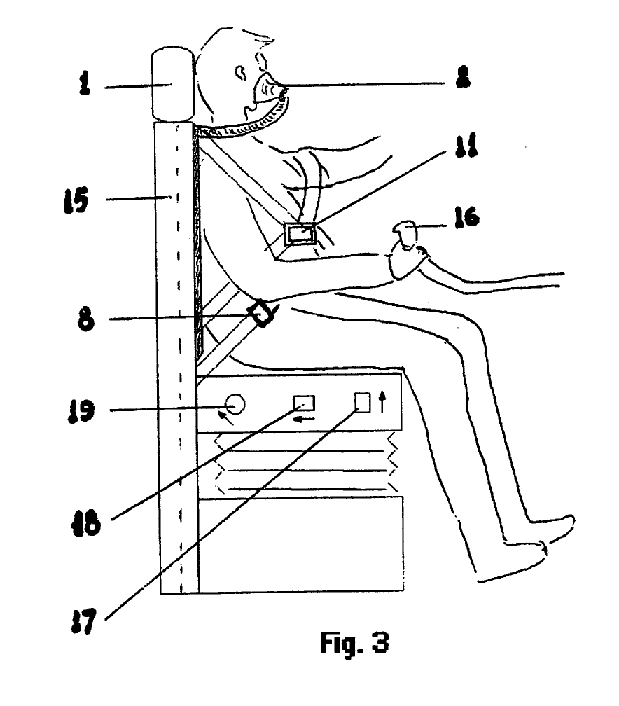

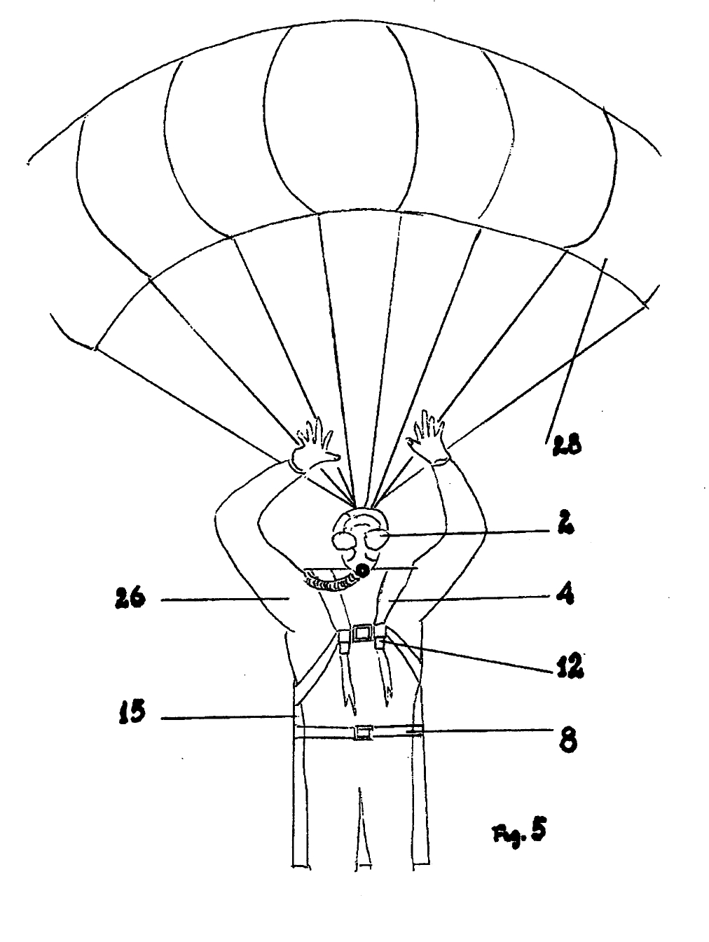

FIG. 1 is a drawing of a pilot or astronaut after ejection from their space shuttle or airplane when their glider wings have spread open. Once a pilot ejects out of his seat, he must open the glider FIG. 2, 10 right away, for the glider's wings won't be able to withstand the strong forces of the gravitational pull and the winds when the forces have been in action for too long. If in a dangerous situation or an outer-space calamity, the pilot astronaut can the press a button FIG. 2, 29 which will, in turn, activate the jet pack FIG. 4, 23. Inside the headrest FIG. 2, 1 of the pilot or astronaut seat, there is an emergency parachute FIG. 5, 28 in case the glider fails or it is necessary to parachute and not glide into the situation. It is deployed by the release button FIG. 2, 9. Also, as any pilot or astronaut would have: goggles FIG. 1, 2, and an oxygen mask FIG. 1, 2. The oxygen mask is connected to a hose FIG. 1, 3, which, consequently, is connected to the oxygen tank FIG. 4, 22 at the back of the ejection seat FIG. 3, 15. When the ejection from the airplane or space shuttle starts, the tank will be disconnected from the air supply of the airplane or space shuttle. The air tank is not that large because the pilot or astronaut will only need to use it for as long as they are out in space or at a high elevation. Once the pilot or astronaut reaches a reasonable elevation, the oxygen supply will not be necessary and can be turned off. There are compartments and storage devices FIG. 4, 20 on the seat containing emergency supplies including a first aid kit, weapons, communication tools, GPS locator, mirror, etc. There is also a box FIG. 4, 21 containing dry foods and water. These tools can be accessed after the person lands safely with the glider or parachute FIG. 5, 28 on the ground. A pilot ejects the whole seat, and then the seat FIGS. 2, 13 & 14 will fall out to discharge the extra weight for the glider. The pilot will be attached to the back of the seat FIG. 3,15 and can control the glider with the straps FIG. 1, 8 from there.

This glider could also be considered an outdoor sport or activity for people like private pilots, parachuters, gliders, or anyone that wants a daring experience.

### FIGURE KEY

FIG. 1
1-Emergency Parachute as headrest
2-Goggle/Oxygen Mask
3-Oxygen hose
4-Shoulder and Chest belt (harness)
5-Upper Arm
6-Lower Arm
7-Aileron
8-Abdomen harness becomes directional maneuvering

FIG. 2
9-Parachute release
10-Glider Release
11-Shoulder and Chest Buckle
12-Adjustable Strap
13-Seat Adjustor
14-Seat cushion
15-Seat Back
29-Jet pack release

FIG. 3
16-Joystick
17-Vertical seat adjustment
18-Horizontal seat adjustment
19-Diagonal seat adjustment

FIG. 4
20-Emergency Cabinet (guns, knife, lighter, etc.)
21-Dry food and drinks
22-Compressed Oxygen Tank
23-Jet Pack
24-Jet pack Exhaust
25-Lower locked pin
27-Upper locked pin
A-Main Spring
B-Secondary spring
C-Oxygen Valve

FIG. 5
26-Pilot or Astronaut
28-Parachute

What is claimed:

1. Ejection seat FIG. 3, 15
A) Seat back (before ejection) FIG. 3, 15
i. Oxygen from the airplane air tank passes through auxiliary oxygen tank inside seat back, then through the regulator, and, finally, into the pilot's mask
a) When seat is ejected, connection with the airplane's air tank will be terminated. The pilot must then depend upon the oxygen remaining within the auxiliary air tank, which should give them at least 2 hours to get to a safe altitude.
ii. equipped with a loran
B) Seat back FIG. 3, 15 and seat FIGS. 2, 13 & 14 designed as separate parts
i. Only seat back FIG. 2, 15 remains attached to person after ejection
C) Emergency parachute doubled as headrest FIG. 1,1
i. Used in the case that the glider FIG. 1 malfunctions or is destroyed
ii. Deployed by release button FIG. 2, 9

2. Glider structure
A) Structure of wing
i. Lock pin FIGS. 4, 25 & 27 and spring FIGS. 4 A&B mechanism
ii. Wings start out resting inside seat back FIG. 2, 15, and then spring out to the sides to form glider FIG. 1
iii. Framework of wings is made of reinforced fiberglass that takes on the form of a bat's wings
B) Seat back (after ejection)
i. Made of aluminum or other lightweight material
ii. Compartments for air tank FIG. 4, 22, jet pack FIG. 4, 23, and supply kits FIG. 4, 20
iii. becomes glider when discharging of wings occurs

3. Purposes of glider
A) Military purposes
i. Pilots can propel themselves out of immediate danger using the jet pack FIG. 4, 23 and glider
B) Astronomical purposes
i. Astronauts can propel themselves into the atmosphere with the jet pack FIG. 4, 23, and, from there, navigate with the glider
C) Recreational purposes
i. the ejection seat can be transformed into a glider used for recreational activities.
